(19) United States
(12) Patent Application Publication
(10) Pub. No.: US 2008/0175765 A1
(43) Pub. Date: Jul. 24, 2008

(54) High throughput, microwave energy heated continuous hydrothermal synthesis apparatus

(76) Inventors: Guang Cao, Branchburg, NJ (US); Sabato Miseo, Pittstown, NJ (US); Stu L. Soled, Pittstown, NJ (US); Jennifer S. Feeley, Oakton, VA (US)

Correspondence Address: ExxonMobil Research and Engineering Company, P.O. Box 900, Annandale, NJ, 08801-0900, US

(21) Appl. No.: 12/001,907

(22) Filed: Dec. 13, 2007

Related U.S. Application Data
(60) Provisional application No. 60/877,272, filed on Dec. 27, 2006.

(51) Int. Cl. B01J 19/12

(52) U.S. Cl. 422/186

(57) ABSTRACT

The present invention is a high throughput apparatus. The apparatus is an automated multi-channel preparation module that prepares a synthesis mixture, microwave heating zone, product collection vessels, and a means for continuously transferring the synthesis mixture through the apparatus.

This Application claims the benefit of U.S. Provisional Application 60/877,272 filed Dec. 27, 2006.

### BACKGROUND OF THE INVENTION

The present invention relates to a high throughput hydrothermal synthesis apparatus. In particular, the apparatus includes a microwave heating zone.

High throughput synthesis has been actively pursued in the prior art, because, for example, exploratory hydrothermal synthesis of zeolitic, AlPO₄/SAPO, and other crystalline oxide materials is a time-consuming and labor-intensive process. The number of synthesis variables in determining the formation of a particular crystalline composition is so numerous that a search for a new composition is spoken of as searching in a synthesis field. The experimental procedures involved in making these materials are reagent addition, mixing, transferring to a pressure vessel (for microporous oxides), sealing of the vessel, heating while optionally providing agitation, cooling, opening the vessel and transferring out the product for washing and drying. All of these procedures may be automated, except that the heating stage typically requires hours and often days, which severely limits the potential for full-chain automation. The present invention turns the conventional batch-wise synthesis into a continuous operation. This is only possible when crystallization rate is dramatically increased. Microwave heating provides such dramatic acceleration vs. conventional heating in zeolite synthesis.

### SUMMARY OF THE INVENTION

A high throughput hydrothermal synthesis apparatus is described. The elements of the apparatus consists of (a) an automated gel/slurry preparation module that prepares an array of synthesis mixture compositions; (b) a multi-channel gel/slurry feeding module to continuously feed the synthesis gels/slurries in parallel fashion into microwave radiated zones where the gels/slurries are quickly heated to and maintained at a preset temperature. In-line static mixers may optionally be used to provide agitation. The flow rate of the gels/slurries, therefore the residence time within the microwave radiated zone, can be varied; (c) an on-line sensing device to monitor the progress of crystallization within each channel; (d) an automated product collection and purification module to collect and purify, in parallel, the synthesis products. The apparatus is controlled with a lab operation software. Sample tracking and monitor reading will be automatically entered into a database that is linked to data to be obtained from sample characterization.

The advantages of the continuous, microwave heated hydrothermal synthesis apparatus over conventional means of batch-wise hydrothermal synthesis are (1) time and labor saved from sealing of a batch reactor; (2) time saved during gel heat up; (3) time saved with acceleration of crystallization caused by microwave radiation; (4) continuous flow allows use of in-line static mixer which eliminates the need for conventional agitation; (5) on-line monitor signal can be fed back into the operation logic so that the residence time of a synthesis gel is determined by the monitor reading. This takes out the guesswork in determining crystallization time; (6) time and labor saved from solid product isolation and washing.

### BRIEF DESCRIPTION OF THE DRAWINGS

FIG. 1 shows a schematic drawing of the apparatus of the present invention.

FIG. 2 shows a schematic drawing of one embodiment of a gel preparation and feeding assembly and a product collection and washing assembly.

FIG. 3 shows X-ray diffraction of the reactant solid products of Example 1.

### DETAILED DESCRIPTION OF THE PREFERRED EMBODIMENTS

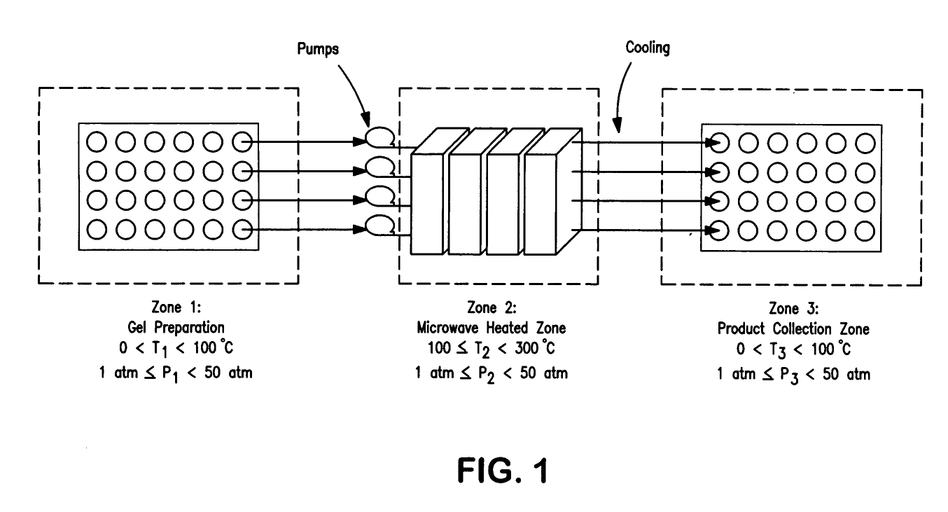

FIG. 1 provides an overall schematic drawing of the synthesis apparatus. The apparatus includes a gel preparation and feeding module, a mechanism for gel flow, a microwave hydrothermal synthesis module, and a product collection and washing module.

### 1. The Gel Preparation Module

The gel preparation module includes parallel channels so that the gel in each channel will continuously progress through the apparatus. Liquid and solid dispensing and handling robotics is commercially available. For example, Chemspeed Technologies provides a solid/liquid dispensing station, Accelerator™ VLT100, that can provide solid and liquid addition of ingredients for hydrothermal synthesis. The wells on such a station can be fitted with heating or agitation mechanisms necessary for preparation of synthesis slurry or gel. A robot of this sort is needed to quickly provide a large array of synthesis gels having varied compositions to the central microwave synthesis module.

2. Mechanism for Gel flow

Commercially available slurry pumps may be used to drive the gel through the synthesis module. In one embodiment, one column of wells on the well plate (FIG. 1) may simultaneously supply gel mixtures to an array of gel pumps. The number of wells on the column is greater or equal to the number of gel pumps. The feed rate (pumping rate) can be adjusted individually, even down to zero, so that the residence time of the gel in the microwave heated zone can be varied. Due to pressure buildup from heated water and/or volatile organics that may be present in the hydrothermal synthesis mixture, autogenous pressure of up to 50 atm pressure is common. (For example, in describing the synthesis of SAPO-11 with dipropylamine, a relatively low boiling point organic compound, as the template, David Lesch reported (U.S. Pat. No. 5,296,208) a pressure of 14.8 atm when the gel was heated to 190° C.) To counter this situation the gel feeding and the product collection ends of the system will be equally and sufficiently pressurized with either air or nitrogen so that boiling of water or organics at synthesis temperature is prevented. Since the feeding and collection ends are outside of the heated zone, which is especially important for the collection end), regular rubber O-rings are sufficient for maintaining pressure seal.

### 3. The Microwave Synthesis Module

A bundle of microwave transparent tubes (Teflon® tubes, for example) may be used as conduits for the transport of synthesis gel through the microwaved zones; therefore multiple samples can be synthesized simultaneously. The bundle of microwave-transparent tubes may be wound up to increase its length within the microwaved zones to increase the length of residence time. The bundle may also be arranged geometrically with respect to the microwave field to ensure uniform irradiation of all tubes. Microwave heating zones capable of providing a power gradient along the flow path of the synthesis gels may be needed so that an approximately isothermal profile along the flow path can be attained. This may be achieved by combining multiple microwave ovens in series along the flow path, with each oven operating at a different power output, or by elaborate microwave power focusing schemes such as the use of waveguides. The power output level is controlled electronically with a feedback loop that takes the difference between the preset temperature and the actual gel temperature. If so desired, the temperature in the different zones may be set at different levels for syntheses that are better effected with different temperatures at different stages of the synthesis (nucleation stage vs. growth stage, for example). In order to provide strength to withstand the pressure that may develop during synthesis, the tubes may be sheathed with a reinforcing material such as Kevlar® film. To provide agitation to the synthesis gel, a sufficient number of static mixers may be installed along the flow path. Some in-line crystallization monitoring device may also be included. Such devices include pH meter and electrical conductivity sensor.

### 4. The Product Collection Module

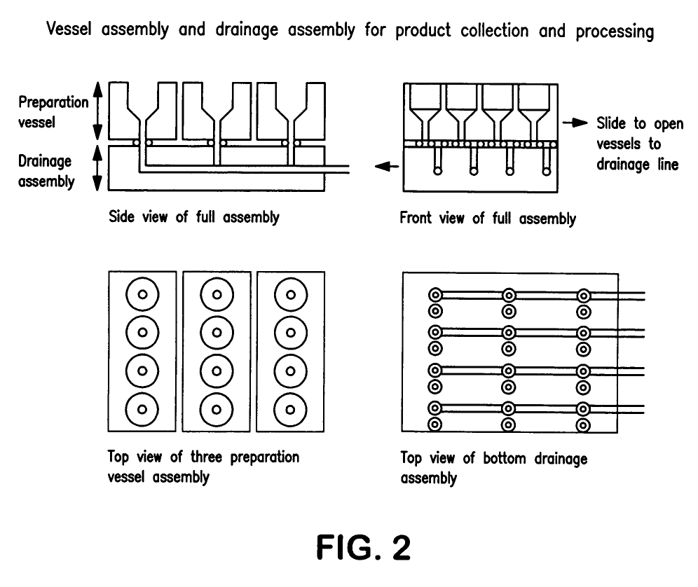

FIG. 2 provides one embodiment of the product collection and filter assembly. It consists of a vessel assembly and a drainage assembly. The vessel assembly is consisted of columns of round-bottom or tapered-bottom wells, with openings at the bottom and frits or screens for filter paper positioned along the openings, and the drainage assembly is a metal plate, which has a set of holes spaced according to the distances between the wells on the vessel assembly. The holes run half way through the plate to connect to a set of parallel channels that are open on one end. Vacuum pumps can be connected to these ends to help drain out liquids from the solid products.

The column of wells on the vessel assembly may slide against the drainage assembly so that all bottom-openings on the wells are either aligned with the opening on the drainage assembly (in the “on” position), or not aligned (in the “off” position). This sliding movement can be achieved by hand or with simple tools such as a wrench, or a screw driver. Around the opening on the vessel assembly, rubber or plastic O-rings are set nearly flush with the surface, so that when the vessel assembly (top) and the drainage assembly (bottom) are put together (by sliding one into another like a drawer, for example), the O-rings are pressed against the top surface of the drainage assembly to make a tight seal. In the “Off” position (during product collection or temporary storage, for example), therefore, the liquid containing hydrothermal synthesis mixture will be retained within the wells. When product collection is finished, the openings on the vessel assembly are opened with one lateral move of the plate, and vacuum pump(s) connected to the end of the drainage holes will enable filtration and washing cycles. Meanwhile the feed pump will start to draw deionized water from the feeding side and provide washing liquid to the collection vessels. The water also cleans the synthesis tubes and prepares the system for another round of synthesis. In addition to water, liquids from separate reservoirs may be added for ion exchange or incipient wetness treatment. The degree of washing can be determined with an on-line conductivity meter that measures the electrical conductivity of the drained washing liquid. The washed product is then removed from the collection chamber and dried in a conventional convection oven or with infrared lamp. The dried product is now ready for characterization, which should also be an automated process.

The gel preparation module, the product collection module and the drainage vessel assembly may be one assemble. A schematic of gel preparation, product collection/filter and drainage vessel assembly, is presented in FIG. 2. Using such an assembly, the switching from gel preparation to feeding the gel into the microwave heating zone, and the switching from product collection to filter and washing, can be accomplished with a simple lateral move of the preparation/collection vessel assembly relative to the drainage assembly. This eliminates the tedious steps of gel/product transfer into/out of the reactor vessel, therefore, together with the fast product formation with microwave heating, will result in substantial time saving and reduction in labor intensity.

### EXAMPLE 1

### Accelerated Synthesis of a Hydrotreating Catalyst with Microwave Heating

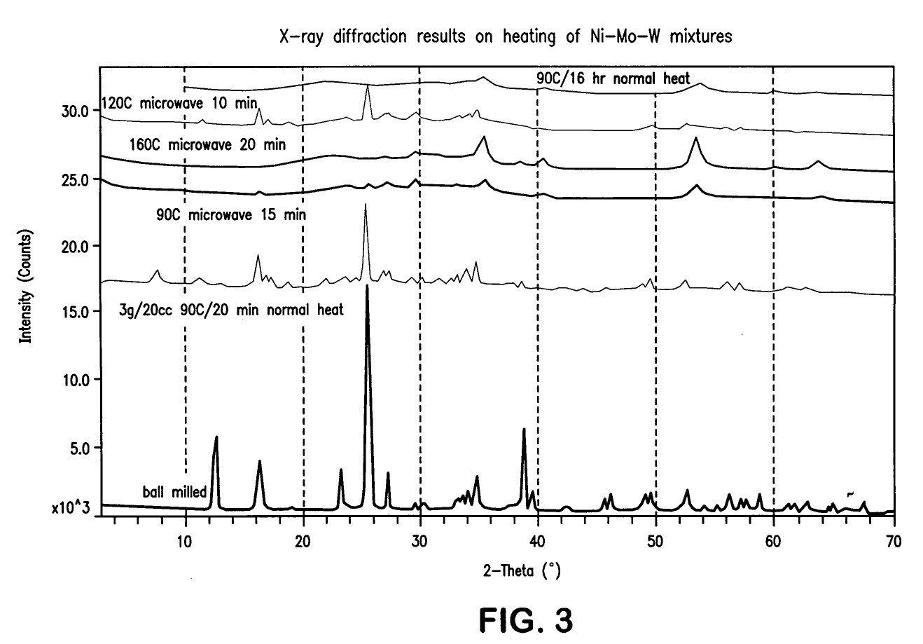

A mixture containing three solid reactants containing Ni, Mo and W in the mole ratios of 1.5, 0.5, 0.5, as described in WO 0041810 A1 was prepared. A portion of this mixture was ballmilled overnight at room temperature. A second portion was added to water forming a slurry and some of this was placed into glass reaction vessel, constantly stirred and heated to 90° C. In one case we heated this slurry for 20 minutes and in a second experiment we heated the slurry for 16 hours as per the prior art disclosure. Other portions or slurry were placed into polymer lined containers and heated in a microwave unit that was designed to control the reaction temperature and time of heat. Three protocols were used. 90° C. for 15 minutes, 120° C. for 10 minutes, and 160° C. for 20 minutes. The reactant solid products were filtered and examined by x-ray diffraction. The results are shown in FIG. 3

FIG. 3 shows that there is no reaction of the ball milled starting solids, only minimal reaction of the normally heated slurry at 90° C. for 20 minutes, full reaction of the 90° C. normally heated sample for 16 hours. The microwave samples at 90° C. for 15 minutes and 160° C. for 20 minutes look nearly fully reacted whereas the 10 minute sample at 120° C., while largely reacted, still has a small amount of reactant remaining. Nonetheless there is a dramatic reduction in reaction time of the slurry reactant mixture with microwave heating vs. conventional heating. This will allow for a rapid continuous microwave heated preparation of this Ni—Mo—W oxide hydrotreating precursor.

What is claimed is:

1. A high throughput hydrothermal apparatus comprising:
(a) an automated multi-channel preparation module at a pressure, P₁, that prepares synthesis mixture compositions from a synthesis gel and/or slurry;
(b) a multiple microwave heating zone at a pressure, P₂;
(c) product collection vessels at a pressure, P₃, that collects synthesis products,
(d) means for continuously transferring said synthesis mixture compositions from preparation module to the microwave heating zone and from the heating zone to the product collection vessels.

2. The apparatus of claim 1 wherein P₁ and P₃ are atmospheric pressure and P₂ is at a pressure such that said mixture compositions do not boil.

3. The apparatus of claim 1 wherein said means for transferring includes one pump.

4. The apparatus of claim 3 wherein said means for transferring includes two pumps.

5. The apparatus of claim 1 wherein said product collection vessels include the number that is equal to the number of parallel tubes in one sequence of synthesis.

6. The apparatus of claim 5 wherein said product collection vessels includes a drainage assembly.

7. The apparatus of claim 6 wherein said drainage assembly communicates with the product collection vessels by a lateral move of the product collection vessels relative to the drainage assembly.

8. The apparatus wherein said preparation module is also the product collection vessel which moves through the microwave zone.
